(19) United States
(12) Patent Application Publication
(10) Pub. No.: US 2024/0422618 A1
(43) Pub. Date: Dec. 19, 2024

(54) TECHNIQUES FOR ENHANCED DOWNLINK DATA DELIVERY

(71) Applicant: QUALCOMM Incorporated, San Diego, CA (US)

(72) Inventors: Alfred ASTERJADHI, San Diego, CA (US); George CHERIAN, San Diego, CA (US); Abhishek Pramod PATIL, San Diego, CA (US); Gaurang NAIK, San Diego, CA (US); Abdel Karim AJAMI, San Diego, CA (US); Sai Yiu Duncan HO, San Diego, CA (US); Yanjun SUN, San Diego, CA (US)

(21) Appl. No.: 18/740,708

(22) Filed: Jun. 12, 2024

Related U.S. Application Data
(60) Provisional application No. 63/508,487, filed on Jun. 15, 2023.

(51) Int. Cl. H04W 28/02

(52) U.S. Cl. CPC H04W 28/0278

(57) ABSTRACT

This disclosure provides methods, components, devices, and systems for enhanced downlink (DL) data delivery. Some aspects more specifically relate to reducing the latency and power consumption associated with delivering DL buffered units (BUs) to stations (STAs) in an enhanced delivery mode. In some implementations, an access point (AP) may transmit an indication of queue information associated with one or more pending DL BUs for a STA. The AP may identify a set of operational parameters to use for transmission of the one or more pending DL BUs in accordance with the queue information. Likewise, the STA may identify a set of operational parameters to use for reception of the one or more pending DL BUs in accordance with the queue information. The AP may transmit the one or more pending DL BUs to the STA in accordance with the queue information and the set of operational parameters.

### CROSS REFERENCE

The present application for patent claims the benefit of U.S. Provisional Patent Application No. 63/508,487 by ASTERJADHI et al., entitled “TECHNIQUES FOR ENHANCED DOWNLINK DATA DELIVERY,” filed Jun. 15, 2023, assigned to the assignee hereof, and expressly incorporated by reference herein.

### TECHNICAL FIELD

This disclosure relates to wireless communication and, more specifically, to techniques for enhanced downlink (DL) data delivery.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts Beacon frames to enable any STAs within wireless range of the AP to establish or maintain a communication link with the WLAN.

In some WLANs, a STA may periodically transition an enhanced delivery mode of the STA (e.g., from an active mode to a power saving (PS) mode) to conserve power. However, delivering downlink (DL) data to a STA in PS mode can sometimes result in delays, signaling overhead, and extraneous power consumption.

### SUMMARY

The systems, methods, and devices of this disclosure each have several innovative aspects, no single one of which is solely responsible for the desirable attributes disclosed herein.

In some embodiments, a method may include: transmitting an indication of queue information associated with one or more pending downlink (DL) buffered units (BUs) for a station (STA) in an enhanced delivery mode; identifying, in accordance with the queue information associated with the one or more pending DL BUs, a plurality of operational parameters to use for transmission of the one or more pending DL BUs; and transmitting the one or more pending DL BUs to the STA in accordance with the queue information and the plurality of operational parameters.

In some embodiments, an apparatus for wireless communications at an access point (AP) may include a processing system that includes processor circuitry and memory circuitry that stores code. The processing system may be configured to cause the apparatus to: transmit an indication of queue information associated with one or more pending DL BUs for a STA in an enhanced delivery mode; identify, in accordance with the queue information associated with the one or more pending DL BUs, a plurality of operational parameters to use for transmission of the one or more pending DL BUs; and transmit the one or more pending DL BUs to the STA in accordance with the queue information and the plurality of operational parameters.

Some embodiments described herein may further include operations, features, means, or instructions for transmitting a request for the STA to use a second plurality of operational parameters for reception of the one or more pending DL BUS, where the one or more pending DL BUs may be transmitted in accordance with the request.

In some embodiments, a method may include: receiving, while the STA is in an enhanced delivery mode, an indication of queue information associated with one or more pending DL BUs for the STA; identifying, in accordance with the queue information associated with the one or more pending DL BUs, a plurality of operational parameters to use for reception of the one or more pending DL BUs; and receiving the one or more pending DL BUs from an AP in accordance with the queue information and the plurality of operational parameters.

In some embodiments, an apparatus for wireless communications at an STA may include a processing system that includes processor circuitry and memory circuitry that stores code. The processing system may be configured to cause the apparatus to: receive, while the STA is in an enhanced delivery mode, an indication of queue information associated with one or more pending DL BUs for the STA; identify, in accordance with the queue information associated with the one or more pending DL BUs, a plurality of operational parameters to use for reception of the one or more pending DL BUs; and receive the one or more pending DL BUs from an AP in accordance with the queue information and the plurality of operational parameters.

Some embodiments described herein may further include operations, features, means, or instructions for transmitting an indication of a second plurality of operational parameters the STA intends to use for reception of the one or more pending DL BUs, where the one or more pending DL BUs may be received in accordance with the indication.

### BRIEF DESCRIPTION OF THE DRAWINGS

FIG. 1 shows a pictorial diagram of an example wireless local area network (WLAN) that supports techniques for enhanced downlink (DL) data delivery.

FIG. 2 shows an example protocol data unit (PDU) usable for communications between a wireless access point (AP) and one or more wireless stations (STAs) that support techniques for enhanced DL data delivery.

FIG. 3 shows an example physical layer (PHY) protocol data unit (PPDU) usable for communications between a wireless AP and one or more wireless STAs that support techniques for enhanced DL data delivery.

FIG. 4 shows a hierarchical format of an example PPDU usable for communications between a wireless AP and one or more wireless STAs that support techniques for enhanced DL data delivery.

FIG. 5 shows an example signaling diagram of wireless communications between a wireless AP and a wireless STA in a WLAN that support techniques for enhanced DL data delivery.

FIG. 6 shows an example process flow between a wireless AP and a wireless STA in a WLAN that support techniques for enhanced DL data delivery.

FIGS. 7 and 8 show block diagrams of example wireless communication devices that support techniques for enhanced DL data delivery.

FIGS. 9 and 10 show flowcharts illustrating example processes that are performable by wireless communication devices that support techniques for enhanced DL data delivery.

Like reference numbers and designations in the various drawings indicate like elements.

### DETAILED DESCRIPTION

The following description is directed to some particular implementations for the purposes of describing innovative aspects of this disclosure. However, a person having ordinary skill in the art will readily recognize that the teachings herein may be applied in a multitude of different ways. Some or all of the described implementations may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others.

The described implementations may be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user (MU) shared access (MUSA), single-user (SU) multiple-input multiple-output (MIMO) and MU-MIMO. The described implementations also may be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

In some WLANs, a wireless station (STA) may periodically or sporadically transition from an active mode to a power saving (PS) mode to conserve power. Further, in some examples, the PS mode may be referred to as an enhanced delivery mode that can include a PS mode or an active mode (AM). When operating in the active mode, the STA is always awake and capable of transmitting and receiving frames at any time. While operating in the PS mode, the STA may switch between a doze state (where the STA is inactive) and an awake state (where the STA is capable of transmitting and receiving frames). When the PS STA is in an awake state, it can monitor for Beacon frames from a wireless access point (AP). A Beacon frame may include a traffic indicator map (TIM) information element (IE) that identifies which STAs have pending downlink (DL) data. If the AP has pending DL data to deliver to the STA (as indicated by the TIM IE), the STA may transmit a frame (such as a PS-Poll frame, QoS Null or QoS Data frame) to notify the AP that the STA is awake (and is thus available to receive the pending DL data from the AP). When the frame is a QoS Null frame or QoS Data frame that solicits an immediate response the Power Management bit in the Frame Control field is set to 1 to indicate that the STA is in PS mode and is set to 0 to indicate that the STA is transitioning to active mode. Similar power saving protocols may be used when the AP is in a PS mode or when the STA is operating in a peer-to-peer (P2P) mode.

In some cases, however, the AP may be restricted in its ability to deliver more than one packet, such as a buffered unit (BU) or a protocol data unit (PDU) to the STA at a given time (e.g., due to the power management (PM) mode the STA is using). For example, if the STA is in PS mode and sends a PS-Poll then the AP may be restricted to only sending a single DL packet to the STA and if the STA is in PS mode and sends a QoS Null or QoS Data frame, then the AP may be restricted to sending a limited number of DL packets to the STA (as many as advertised by the STA during association that it supports in reception when in this particular PS mode (namely, APSD)). Thus, if the AP has multiple DL packets to deliver to the STA, the STA may exit the PS mode (e.g., enter active mode) or transmit additional PS-Poll frames to solicit each of the additional DL packets from the AP. In some implementations, the STA may remain in an awake state and/or transition from the doze state to the awake state until all pending DL packets have been delivered, which can cause delays, power consumption, etc. Further, the AP may keep all pending DL packets buffered until they are delivered, which can result in buffer overflows and scheduling complications.

One or more innovative aspects of the subject matter described in this disclosure may be implemented to reduce the delay, power consumption, and airtime utilization associated with delivering DL data to PS STAs. In some implementations, to improve the efficiency of DL data delivery, the AP may provide a STA (such as a STA in an active mode or an awake state) with queue information, such that the AP can deliver pending DL BUs to the STA with greater efficiency, lower signaling overhead, reduced latency, etc. The queue information provided by the AP may indicate, for example, the number of pending DL BUs for the STA, a time duration for which the DL BUs have been pending, or a time duration after which the pending DL BUs will be dropped, a score that determines the priority of delivery of these pending DL BUS (determined by the AP, or provided by the higher layers (e.g., application layer), among other implementations.

Additionally, or alternatively, the AP may configure or otherwise instruct the STA to use a specific set of operational parameters for reception of the pending DL BUs. For example, the AP may instruct the STA to increase its maximum receive (RX) bandwidth (BW), and/or maximum number of spatial streams (NSS) for an upcoming service period (SP), thereby enabling the AP to deliver a larger amount of DL data to the STA in a shorter amount of time. The AP may provide the queue information and/or the operational parameters via a Beacon frame, a Trigger frame, an individually addressed frame, a group-addressed frame, or a separate broadcast frame. In some implementations, the AP also may provide the STA with link-specific information, such as how long it will take to deliver all pending DL BUs to the STA (such as a STA affiliated with a multi-link capable device (MLD)) on a given communication link. The AP may also provide the STA with a list of the links that the AP intends to deliver the pending DL BUs, and eventually specify that the queue information, and/or the operational parameters are applicable to all of the communication links that it has setup with the MLD to which the STA is affiliated with or to each of the communication links (e.g., each link has its own queue information and/or operational parameters). The link-specific information may enable the STA to retrieve the pending DL BUs from the AP with greater efficiency, reduced latency, etc.

Particular aspects of the subject matter described in this disclosure may be implemented to realize one or more of the following potential advantages. In some implementations, by providing the STA with queue information (such as the number of pending DL BUs for the STA, the total size of the pending DL BUs, or the queue size in octets), the described techniques may enable and/or motivate the STA to retrieve the pending DL BUs with greater efficiency, reduced latency, and reduced power consumption. For example, instead of sending a PS-Poll frame to the AP, receiving one medium access control (MAC) PDU (MPDU) in response (e.g., a single pending DL BU), and repeating the process until all pending DL BUs are delivered, the STA may switch from PS mode to active mode and/or use a particular RX configuration (such as a maximum RX BW or NSS) to receive a larger number of DL BUs from the AP in a shorter time span, after which the STA can return to a PS mode and continue to conserve power.

Further, although some wireless communications systems may support using Trigger frames to solicit (e.g., trigger) UL packets from a STA, such techniques may be limited to UL communications (e.g., where an AP uses a Trigger frame to notify the STA of which resources are available for UL packets/data). The enhanced DL delivery techniques described herein provide for notifying a STA of upcoming (e.g., pending) DL packets/data, such that the STA can prepare to receive the pending DL packets/data with greater efficiency, higher throughput, reduced latency, etc.

The DL delivery enhancements described herein are applicable to various wireless communication protocol standards, including (but not limited to) IEEE 802.11bn, which supports ultra-high reliability (UHR) communications. The techniques described herein may reduce the latency and power consumption associated with DL reception for UHR STAs (such as STAs that support UHR communications). Also, providing the AP and/or the STA with an opportunity to indicate the duration of time and, in some implementations, the maximum number of spatial streams (NSSs), along with other transmission (TX)/reception (RX) parameters, available for DL delivery may promote greater coexistence and improved resource management for UHR devices.

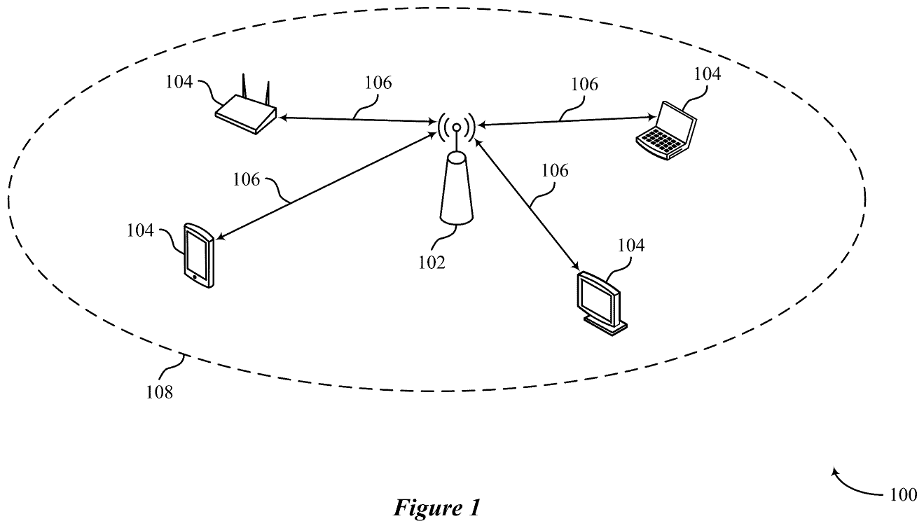

FIG. 1 shows a pictorial diagram of an example WLAN 100. According to some aspects, the WLAN 100 may be an example of a Wi-Fi network. For example, the WLAN 100 may be a network implementing at least one of the IEEE 802.11 family of wireless communication protocol standards (such as that defined by the IEEE 802.11-2020 specification or amendments thereof including, but not limited to, 802.11ay, 802.11ax, 802.11az, 802.11ba, 802.11bd, 802.11be, 802.11bf, and the 802.11 amendment associated with Wi-Fi 8). The WLAN 100 may include numerous wireless communication devices such as a wireless AP 102 and multiple wireless STAs 104. While only one AP 102 is shown in FIG. 1, the WLAN 100 also can include multiple APs 102. AP 102 shown in FIG. 1 can represent various different types of APs including but not limited to enterprise-level APs, single-frequency APs, dual-band APs, standalone APs, software-enabled APs (soft APs), and multi-link APs. The coverage area and capacity of a cellular network (such as LTE, 5G NR, etc.) may be further improved by a small cell which is supported by an AP 102 serving as a miniature base station. Furthermore, private cellular networks also may be set up through a wireless area network using small cells.

Each of the STAs 104 also may be referred to as a mobile station (MS), a mobile device, a mobile handset, a wireless handset, an access terminal (AT), a user equipment (UE), a subscriber station (SS), or a subscriber unit, among other implementations. The STAs 104 may represent various devices such as mobile phones, personal digital assistant (PDAs), other handheld devices, netbooks, notebook computers, tablet computers, laptops, chromebooks, extended reality (XR) headsets, wearable devices, display devices (for example, TVs (including smart TVs), computer monitors, navigation systems, among others), music or other audio or stereo devices, remote control devices (“remotes”), printers, kitchen appliances (including smart refrigerators) or other household appliances, key fobs (for example, for passive keyless entry and start (PKES) systems), Internet of Things (IoT) devices, and vehicles, among other implementations. The various STAs 104 in the network are able to communicate with one another via the AP 102.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the WLAN 100. The BSS may be identified or indicated to users by a service set identifier (SSID), as well as to other devices by a BSS identifier (BSSID), which may be a MAC address of the AP 102. The AP 102 may periodically broadcast Beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102.

For example, the beacons can include an identification or indication of a primary channel used by the respective AP 102 as well as a timing synchronization function for establishing or maintaining timing synchronization with the AP 102. Additionally, or alternatively, the beacons may indicate the presence of pending DL BUs for a particular STA 104. For instance, a TIM IE in a beacon may include a plurality of bits corresponding to a plurality of STAs 104 served by the AP 102. If a particular bit is set to 1, the corresponding STA 104 may infer, from the beacon, that the AP has pending DL BUs buffered for the STA 104.

The AP 102 may provide access to external networks to various STAs 104 in the WLAN via respective communication links 106. To establish a communication link 106 with an AP 102, each of the STAs 104 is configured to perform passive or active scanning operations (“scans”) on frequency channels in one or more frequency bands (for example, the 2.4 gigahertz (GHz), 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. A STA may use passive scanning techniques, active scanning techniques, or both while operating in a PS mode or an active mode. The AP 102 assigns an association identifier (AID) to the STA 104 at the culmination of the association operations, which the AP 102 uses to track the STA

The APs 102 and STAs 104 may function and communicate (via the respective communication links 106) according to one or more of the IEEE 802.11 family of wireless communication protocol standards. These standards define the WLAN radio and baseband protocols for the PHY and MAC layers. The APs 102 and STAs 104 transmit and receive wireless communications (hereinafter also referred to as “Wi-Fi communications” or “wireless packets”) to and from one another in the form of PPDUs. The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 megahertz (MHz) band. Some implementations of the APs 102 and STAs 104 described herein also may communicate in other frequency bands, such as the 5.9 GHZ and the 6 GHz bands, which may support both licensed and unlicensed communications. The APs 102 and STAs 104 also can communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax, 802.11be, and 802.11bn standard amendments may be transmitted over the 2.4 GHZ, 5 GHz, 6 GHZ, or 60 GHz bands, each of which is divided into multiple 20 MHZ channels. As such, these PPDUs are transmitted over a physical channel having a minimum BW of 20 MHz, but larger channels may be formed through channel bonding. For example, PPDUs may be transmitted over physical channels having BWs of 40 MHz, 80 MHz, 160 MHz, 320 MHz, 480 MHz, 640 MHz, or 1280 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 protocol to be used to transmit the payload.

As described herein, an AP 102 may transmit an indication of queue information associated with one or more pending DL BUs for a STA 104 that is in an enhanced delivery mode. The enhanced delivery mode may include a PS mode or an AM. The AP 102 may identify, in accordance with the queue information associated with the one or more pending DL BUs, a first set of operational parameters to use for transmission of the one or more pending DL BUs. The first set of operational parameters may include one or more of a BW, an NSS, an MCS, a PPDU type, a preamble puncture pattern, etc. to use for transmission of the one or more pending DL BUs. The first set of operational parameters may, in some examples, vary according to the queue information provided. For example, the AP 102 may identify a higher MCS if there are many DL BUs pending for the STA 104. In contrast, the AP 102 may identify a lower MCS if there are fewer DL BUs pending for the STA 104.

Likewise, the STA 104 may identify, in accordance with the queue information associated with the one or more pending DL BUs, a second set of operational parameters to use for reception of the one or more pending DL BUs. The second set of operational parameters may include one or more of a BW, an NSS, or an MCS to use for reception of the one or more pending DL BUs. The AP 102 may transmit the one or more pending DL BUs to the STA 104 in accordance with the queue information and the first set of operational parameters or the second set of operational parameters, or a common set of operational parameters obtained from the first and second set. In some implementations, the first set of operational parameters may be the maximum values advertised by the AP 102. When the pending DL BUs are delivered, the STA 104 may select the second set of operational parameters within the bounds of the first set of operational parameters advertised by the AP 102. For example, if the first set of operational parameters signaled by the AP 102 include a maximum NSS value of 4, the second set of operational parameters selected by the STA 104 may include an NSS value that is within the bounds of (e.g., less than or equal to) the maximum NSS value advertised by the AP 102. Accordingly, the STA 104 may use the selected NSS value (e.g., 3) for reception of the pending DL BUs. In some implementations, the STA 104 may transmit an indication of the second set of operational parameters to the AP 102 prior to delivery of the pending DL BUs (so the AP 102 is aware of which operational parameters the STA intends to use).

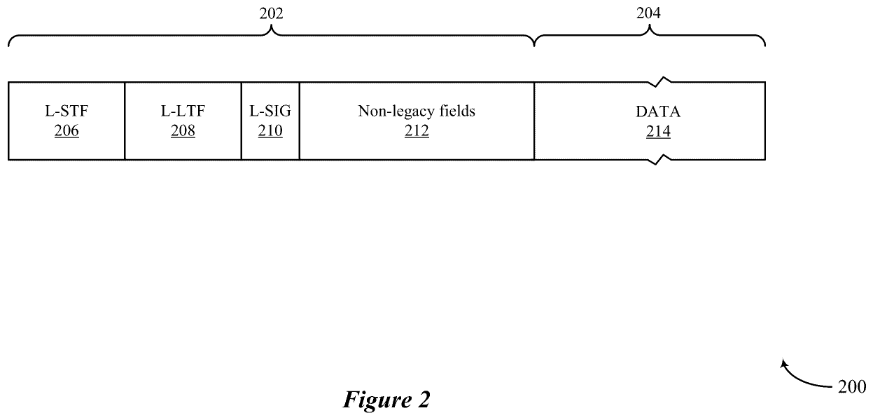

FIG. 2 shows an example PDU 200 usable for wireless communication between a wireless AP 102 and one or more wireless STAs 104. For example, the PDU 200 may be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device to perform coarse timing and frequency tracking and automatic gain control (AGC). The L-LTF 208 generally enables a receiving device to perform fine timing and frequency tracking and also to perform an initial estimate of the wireless channel. The L-SIG 210 generally enables a receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MPDUs or an aggregated MPDU (A-MPDU).

As described above, an AP 102 may transmit an indication of queue information associated with one or more pending DL BUs for a STA 104 in an enhanced delivery mode. In some implementations, the queue information may be carried in a MAC header of a PDU 200. In particular, the queue information may be conveyed via one or more IEs (such as a buffer status report (BSR) IE) in the DATA 214 of a PDU 200 (such as a Beacon frame or a broadcast frame). The BSR IE may indicate a list of BSRs, each BSR for a given STA 104 (not necessarily limited to STAs 104 in PS mode), where the STA 104 is identified by an AID subfield in the BSR IE, or another element, such as an AID Bitmap element. The BSR for a given STA 104 may indicate all pending DL BUs (independent of TIDs), for each TID, or for each AC. The AP 102 may transmit the one or more pending DL BUs (which may be implementations of the PDU 200) to the STA 104 in accordance with the queue information.

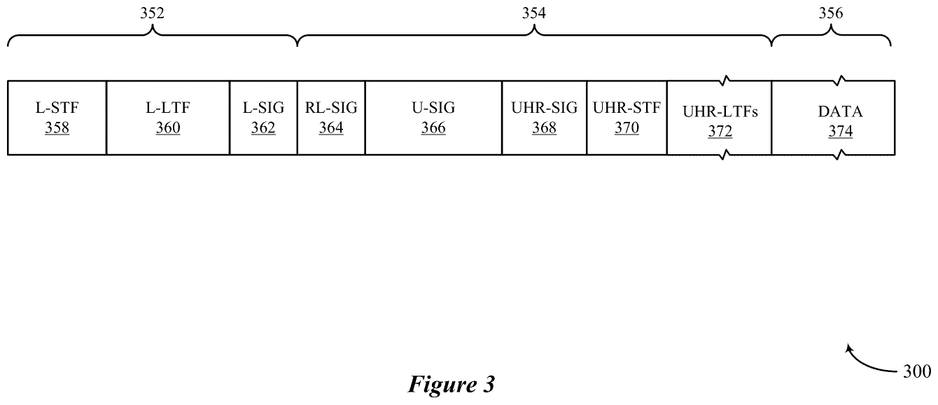

FIG. 3 shows another example PPDU 300 usable for wireless communication between a wireless AP 102 and one or more wireless STAs 104. The PPDU 300 may be used for SU, OFDMA or MU-MIMO transmissions. The PPDU 300 may be formatted as an EHT WLAN PPDU in accordance with the IEEE 802.11be amendment to the IEEE 802.11 family of wireless communication protocol standards, or may be formatted as a PPDU conforming to any later (post-EHT) version of a new wireless communication protocol conforming to a future IEEE 802.11 wireless communication protocol standard, such as the 802.11 amendment associated with Wi-Fi 8), or another wireless communication standard. The PPDU 300 includes a PHY preamble including a legacy portion 352 and a non-legacy portion 354. The PPDU 300 may further include a PHY payload 356 after the preamble, for example, in the form of a PSDU including a data field 374.

The legacy portion 352 of the preamble includes an L-STF 358, an L-LTF 360, and an L-SIG 362. The non-legacy portion 354 of the preamble includes a repetition of L-SIG (RL-SIG) 364 and multiple wireless communication protocol version-dependent signal fields after RL-SIG 364. For example, the non-legacy portion 354 may include a universal signal field (referred to herein as “U-SIG 366”) and an ultra-high reliability (UHR) signal field (referred to herein as “UHR-SIG 368”). The presence of RL-SIG 364 and U-SIG 366 may indicate to UHR- or later version-compliant STAs 104 that the PPDU 300 is an EHT PPDU or a PPDU conforming to any later (post-EHT) version of a new wireless communication protocol conforming to a future IEEE 802.11 wireless communication protocol standard.

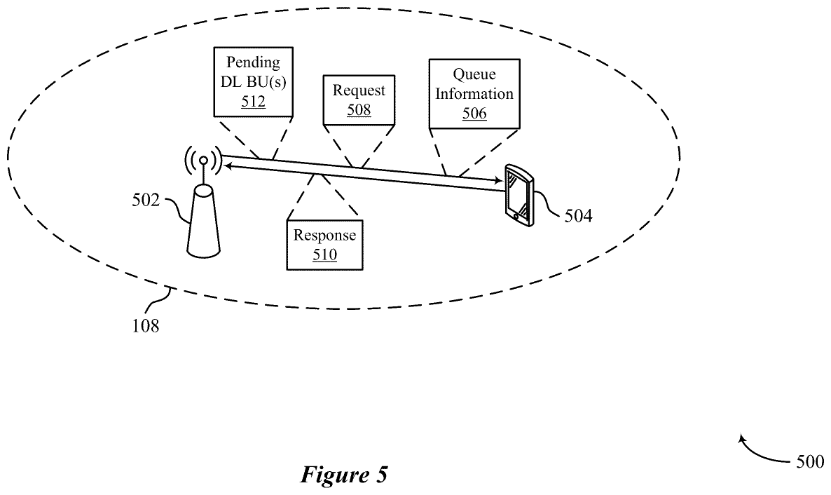

UHR is an IEEE 802.11 wireless communication protocol standard that supports greater communication reliability through the use of distributed multi-link operation (MLO), integrated millimeter wave (mmW) operations, and AP coordination, among other implementations. In some implementations, a UHR AP 102 (such as an AP 102 that supports UHR communications) may provide queue information that pertains to a quantity of pending DL BUs buffered for a particular UHR STA 104 (such as a STA 104 that supports UHR communications). Providing queue information to a UHR STA 104 (such as the STA 504 shown and described with reference to FIG. 5) may enable a UHR AP 102 (such as the AP 502 shown and described with reference to FIG. 5) to deliver DL BUs to the UHR STA 104 with reduced latency, lower signaling overhead and improved network resources utilization.

One or both of U-SIG 366 and UHR-SIG 368 may be structured as, and carry version-dependent information for, other wireless communication protocol versions associated with amendments to the IEEE family of standards beyond UHR. For example, U-SIG 366 may be used by a receiving device to interpret bits in one or more of UHR-SIG 368 or the data field 374. Like L-STF 358, L-LTF 360, and L-SIG 362, the information in U-SIG 366 and UHR-SIG 368 may be duplicated and transmitted in each of the component 20 MHz channels in instances involving the use of a bonded channel.

The non-legacy portion 354 further includes an additional STF 370 (referred to herein as “UHR-STF 370,” although it may be structured as, and carry version-dependent information for, other wireless communication protocol versions beyond UHR) and one or more additional LTFs (referred to herein as “UHR-LTFs 372” although they may be structured as, and carry version-dependent information for, other wireless communication protocol versions beyond UHR). UHR-STF 370 may be used for timing and frequency tracking and AGC, and UHR-LTF 372 may be used for more refined channel estimation.

An AP 102 may use UHR-SIG 368 to identify and inform one or multiple STAs 104 that the AP 102 has scheduled UL or DL resources for them. UHR-SIG 368 may be decoded by each compatible STA 104 served by the AP 102. UHR-SIG 368 may generally be used by a receiving device to interpret bits in the data field 374. For example, UHR-SIG 368 may include RU allocation information, spatial stream configuration information, and per-user (for example, STA-specific) signaling information. Each UHR-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the quantity of users in allocations, among other implementations. The user-specific fields are assigned to particular STAs 104 and carry STA-specific scheduling information such as user-specific modulation and coding scheme (MCS) values and user-specific RU allocation information. Such information enables the respective STAs 104 to identify and decode corresponding RUs in the associated data field 374.

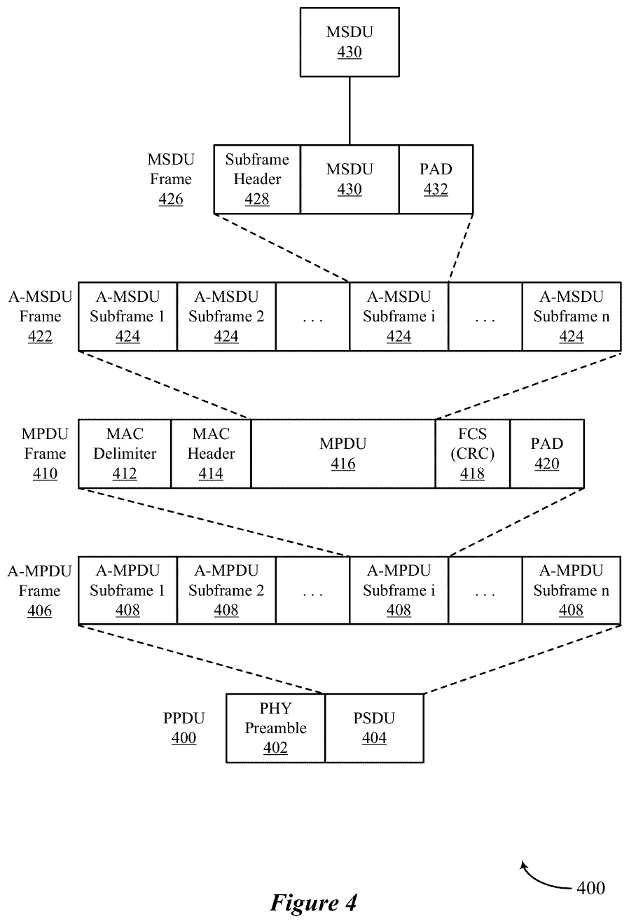

FIG. 4 shows a hierarchical format of an example PPDU usable for communications between a wireless AP 102 and one or more wireless STAs 104. As described, each PPDU 400 includes a PHY preamble 402 and a PSDU 404. Each PSDU 404 may represent (or “carry”) one or more MAC PDUs (MPDUs) 416. For example, each PSDU 404 may carry an aggregated MPDU (A-MPDU) 406 that includes an aggregation of multiple A-MPDU subframes 408. Each A-MPDU subframe 408 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (for example, the FCS field may include a cyclic redundancy check (CRC)) and padding bits 420. The MPDU 416 may carry one or more MAC service data units (MSDUs) 426. For example, the MPDU 416 may carry an aggregated MSDU (A-MSDU) 422 including multiple A-MSDU subframes 424. Each A-MSDU subframe 424 contains a corresponding MSDU 430 preceded by a subframe header 428 and in some implementations followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body. The MAC header 414 includes a Duration field indicating a duration extending from the end of the PPDU until at least the end of an acknowledgment (ACK) or Block ACK (BA) of the PPDU that is to be transmitted by the receiving wireless communication device.

The use of the Duration field serves to reserve the wireless medium for the indicated duration, and enables the receiving device to establish its network allocation vector (NAV). The MAC header 414 also includes one or more fields indicating addresses for the data encapsulated within the frame body. For example, the MAC header 414 may include a combination of a source address, a transmitter address, a receiver address, or a destination address. The MAC header 414 may further include a frame control field containing control information. The frame control field may specify a frame type, for example, a data frame, a control frame, or a management frame.

Some APs 102 and STAs 104 may implement techniques for spatial reuse that involve participation in a coordinated communication scheme. According to such techniques, an AP 102 may contend for access to a wireless medium to obtain control of the medium for a transmit opportunity (TXOP). The AP 102 that wins the contention (hereinafter also referred to as a “sharing AP”) may select one or more other APs 102 (hereinafter also referred to as “shared APs”) to share resources of the TXOP. The sharing and shared APs 102 may be located in proximity to one another such that at least some of their wireless coverage areas at least partially overlap. Some implementations may specifically involve coordinated AP TDMA or OFDMA techniques for sharing the time or frequency resources of a TXOP. To share its time or frequency resources, the sharing AP 102 may partition the TXOP into multiple time segments or frequency segments each including respective time or frequency resources representing a portion of the TXOP, The sharing AP 102 may allocate the time or frequency segments to itself or to one or more of the shared APs 102. For example, each shared AP 102 may utilize a partial TXOP assigned by the sharing AP 102 for its uplink (UL) or DL communications with its associated STAs 104.

In some implementations of such TDMA techniques, each portion of a plurality of portions of the TXOP includes a set of time resources that do not overlap with any time resources of any other portion of the plurality of portions. In such implementations, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for MU TDMA.

In some other implementations of OFDMA techniques, each portion of the plurality of portions of the TXOP includes a set of frequency resources that do not overlap with any frequency resources of any other portion of the plurality of portions. In such implementations, the scheduling information may include an indication of frequency resources, of multiple frequency resources of the TXOP, associated with each portion of the TXOP. For example, the scheduling information may include an indication of a BW portion of the wireless channel such as an indication of one or more subchannels or RUs associated with each portion of the TXOP such as for MU OFDMA.

In this manner, the sharing AP acquisition of the TXOP enables communication between one or more additional shared APs 102 and their respective BSSs, subject to appropriate power control and link adaptation. For example, the sharing AP 102 may limit the transmit powers of the selected shared APs 102 such that interference from the selected APs 102 does not prevent STAs 104 associated with the TXOP owner from successfully decoding packets transmitted by the sharing AP 102. Such techniques may be used to reduce latency because the other APs 102 may not need to wait to win contention for a TXOP to be able to transmit and receive data according to conventional CSMA/CA or enhanced distributed channel access (EDCA) techniques.

For UL MU transmissions, an AP 102 can transmit a Trigger frame to initiate and synchronize an UL MU-OFDMA or UL MU-MIMO transmission from multiple STAs 104 to the AP 102. Such Trigger frames may thus enable multiple STAs 104 to send UL traffic to the AP 102 concurrently in time. A Trigger frame may address one or more STAs 104 through respective association identifiers (AIDs), and may assign each AID (and thus each STA 104) one or more RUs that may be used to send UL traffic to the AP 102. The AP 102 also may designate one or more random access (RA) RUs for which unscheduled STAs 104 may contend.

As described above, an AP 102 may transmit an indication of queue information associated with one or more pending DL BUs for a STA 104 in an enhanced delivery mode. In some implementations, the queue information may be carried in a MAC header 414 of an MPDU frame 410, which may be part of an A-MPDU subframe 408 of an A-MPDU frame 406. In some other implementations, the queue information may be carried in an IE or a field contained in the Frame Body of the MPDU frame 410. The A-MPDU frame 406 containing the queue information may be included in a PSDU 404 of a PPDU 400 (such as a Beacon frame or a broadcast frame). The queue information provided by the AP 102 may enable the AP 102 deliver DL BUs (such as MSDUs 430 or A-MSDU frames 422) to STAs 104 with greater efficiency, reduced latency, and lower signaling overhead, among other benefits. The DL delivery enhancements described herein may be applicable to all STAs 104 (not just STAs 104 in PS mode), as the operational parameters described herein apply to STAs 104 that are in active mode as well. For example, the AP 102 can request a STA 104 that is in active mode to transition from a 20 MHz 1 SS mode to a 160 MHz 2 SS mode. In some implementations, the AP may instruct a STA 104 to use a particular channel via an off-channel indication. In some embodiments, the transition from one mode to another may be based on a buffer status threshold, which may be notified to the STA 104 in advance (e.g., during association, via a management frame exchange, etc.).

FIG. 5 shows a pictorial diagram of a signaling diagram 500. The signaling diagram 500 may implement or be implemented by aspects of the WLAN 100. For example, the signaling diagram 500 includes an AP 502, which may be an example of aspects of a wireless AP, such as the AP 102 shown and described with reference to FIG. 1. The signaling diagram 500 also includes a STA 504, which may be an example of aspects of a wireless STA, such as one of the STAs 104 shown and described with reference to FIG. 1. As shown and described in the example of FIG. 5, the AP 502 may improve the efficiency of DL data delivery for UHR STAs (such as the STA 504) by providing the UHR STAs with queue information 506 that pertains to pending DL BU(s) 512 and/or indicating/negotiating the use of a set of operating parameters for the delivery of said pending DL BU(s).

As described herein, including with reference to FIGS. 1-4, an IEEE 802.11 STA (such as the STA 504) can operate in an active mode or a PS mode. While in an active mode, the STA 504 is awake and capable of transmitting and receiving frames at any time. The STA 504 may indicate that it is in active mode by sending, to the AP 502, a frame with a PM bit set to 0.

In a PS mode, the STA 504 is awake at specified times, during which it is capable of transmitting and receiving with some constraints. For example, due to PS data delivery constraints and traffic scheduling considerations of the AP 502, the STA 504 may be unable to receive more than one MPDU after a PS-Poll frame is sent. Additionally, or alternatively, the STA 504 may be constrained to receiving a particular number of MPDUs after an automatic power save delivery (APSD) Trigger frame is sent, and so on. The STA 504 may indicate that it is in PS mode by sending, to the AP 502, a frame with the PM bit set to 1 and that it is in active mode by sending a frame with the PM bit to 0.

A PS STA (such as the STA 504) may be either in an awake state or a doze state. In an awake state, the STA 504 may be capable of receiving and transmitting frames, subject to any PS mode constraints. In a doze state, the STA 504 may be unable to perform transmission or reception (to save power). The AP 502 may, in some implementations, support DL data delivery to PS STAs. A PS STA (such as the STA 504) may remain in a doze state for most of the time and awake periodically to receive Beacon frames from the AP 502. These Beacon frames may indicate whether there are pending DL BU(s) 512 for the STA 504. This information may be provided in a TIM IE of the Beacon frame.

Upon receiving a Beacon frame that indicates the presence of pending DL BU(s) 512 for the STA 504, the STA 504 may send (to the AP 502) a frame to indicate that the STA 504 has transitioned to an awake state. The particular frame that is used to convey this information may depend on which PS mode the STA 504 is in. For example, a PS-Poll frame may be used for legacy PS modes (such as a TIM mode), and APSD Trigger frames (such as Quality of Service (QOS) Null or QoS Data frames) may be used for APSD mode(s). APSD, which includes both unscheduled APSD (U-APSD) and scheduled APSD (S-APSD), is a power saving mechanism that provides greater efficiency in comparison to legacy PS-Polling schemes. In APSD, PS-Poll frames are replaced with Trigger frames (which may be any sort of data frame), thereby alleviating the need for PS STAs (such as the STA 504) to transmit PS-Poll frames to solicit buffered DL data from the AP 502. In some implementations, the STA 504 can autonomously decide to transition to active mode, by sending a frame with the PM bit set to 0. The AP 502 may schedule DL delivery according to the decision of the STA 504, subject to the following constraints.

The AP 502 may schedule at most one MPDU if the STA 504 sends a PS-Poll frame, and the STA 504 may send more PS-Poll frames to retrieve additional MPDUs from the AP 502. Alternatively, up to X MPDUs may be scheduled within an SP if the STA 504 sends an APSD Trigger frame to the AP 502, where X is indicated by a Max SP Length of a QoS Info field sent by the STA (may be 2, 4, 6, or all). If the STA 504 has transitioned to active mode, the AP 502 can deliver any number of MPDUs to the STA 504, and DL data delivery can continue until the STA 504 transitions back to PS mode again (for example, by setting the PM bit to 1).

In some DL data delivery schemes, the STA 504 may autonomously determine how and when to retrieve pending DL BU(s) 512 from the AP 502. This decision may depend on a single bit in a Beacon frame (such as a TIM bit that indicates the presence of DL BUs for the STA identified by that TIM bit). The AP 502 may keep any pending DL BUs buffered until they are delivered to the STA 504, which can cause delays in data delivery, buffer overflows at the AP, and unexpected changes to the DL schedules (for example, due to unexpected frames from PS STAs). In such implementations, a single bit of information provided by the AP indicates whether there are any pending DL BU(s) for the STA 504. This bit may be used by the STA to make several decisions, such as when to wake and receive a Beacon frame from the AP 502, when to transmit UL Triggering frames and transition to an awake state, whether to remain in PS mode (and which PS mode to use) or switch to active mode, how long to remain in active mode, and which RX parameters (such as, for example, RX BW, and NSS, etc.) to use while in an awake state (noting that the STA may be in awake state in both modes, PS mode and active mode). These decisions may have a direct impact on DL data delivery performance, network performance, power consumption, etc.

Aspects of the subject matter described in this disclosure may be implemented to provide enhancements to DL delivery protocols that reduce DL delivery delay and improve queue management at the AP 502, while reducing power consumption and airtime utilization for DL data delivery. Some implementations of the subject matter described in this disclosure may involve increasing the amount of information delivered by the AP 502 regarding the pending DL BU(s) 512. For example, the AP 502 may provide the STA 504 with queue information 506 that includes or otherwise indicates a BSR, cumulative delay, etc. Aspects of the subject matter described in this disclosure also may reduce the time it takes for the STA 504 to send UL Triggering frames to the AP 502, thereby enabling the STA 504 to perform polling directly after reception of a Beacon frame (trigger, NAV-protected).

Aspects of the subject matter described in this disclosure also may be implemented to improve delivery rates for STAs that would otherwise be in PS mode. For example, the AP 502 may transmit, to the STA 504, a request 508 for the STA 504 to increase its RX capabilities so the AP 502 can deliver a larger amount of data in a shorter period of time. The request 508 may include a request for the STA 504 to switch to active mode (if the STA is in PS mode), a request for the STA 504 to use a maximum RX BW and RX NSS for a period of time (wherein the period of time itself may be part of the parameter set as well), and so on. Alternatively, the request 508 may cause the STA 504 to implicitly switch to active mode, maximum RX BW, maximum RX NSS, etc. In some embodiments, the STA 504 may indicate (in a frame sent to the AP 502) how long the STA 504 will be able to remain in this mode.

To support enhanced DL delivery reporting at the AP 502, the AP 502 may report the amount of data buffered for an UHR STA (such as the STA 504), which may be reported along with the presence of pending DL BU(s) for PS STAs. For example, the AP 502 may continue to provide (in a Beacon frame) a TIM IE that indicates whether there are pending DL BU(s) for the STA 504, while queue information 506 (such as a BSR) may be appended to frames sent by the AP 502. In some implementations, the queue information 506 may be provided by means of a BSR IE in a Beacon frame or a separate broadcast frame. The BSR IE may indicate BSRs for one or more UHR STAs that have pending DL BUs. The queue information 506 may be signaled per traffic identifier (TID), per access category (AC), etc.

In other implementations, the queue information 506 may be provided by means of individually addressed frames (such as QoS Null or QoS Data frames) that are sent to the STA 504. For example, the queue information 506 may be reported via QoS Control or BSR Control fields in a MAC header, etc. In some other implementations, the queue information 506 may be provided via a Trigger frame. If the queue information 506 is reported via a separate broadcast frame, the broadcast frame may be scheduled directly after a Beacon frame. The broadcast frame may include a list of UHR STAs with pending DL BUs and corresponding BSRs for each of the UHR STAs.

Additionally, or alternatively, the queue information 506 may indicate communication links (such as the communication links 106 shown and described with reference to FIG. 1) where each UHR multi-link capable device (MLD) can retrieve the pending DL data. The queue information 506 also may indicate, for each communication link, how long DL BUs have been pending, how much longer before the pending data is dropped (for example, due to buffer overflow or aging), a request for the STA to switch to active mode (or enhanced PS (enhanced PS) mode), a request for the STA to increase RX operation parameters, average wait times for DL data delivery on a given link (which could be provided per-TID or per-AC), a BSS load for each link (which could be signaled per-TID or per-AC), etc. The queue information 506 may, in some implementations, be provided via a Link Recommendation frame or a TIM (broadcast) frame.

Aspects of the subject matter described in this disclosure also may be implemented to enhance PS mode operations at the STA 504. For example, a UHR AP (such as the AP 502) may schedule for TX a control frame (possibly a new variant of a Trigger frame) that is addressed to UHR STAs (not only those in PS mode) which contains the queue information for the UHR STAs and possibly the set of operational parameters to be used by each of the UHR STAs to receive the pending DL BUs and eventually to transmit their pending data frames (UL BUs). In some implementations, the Trigger frame may be addressed to STAs with additional DL delivery reports for each of the STAs. The Trigger frame may be a variant of the MU RTS Trigger frame. The MU RTS Trigger frame, which may contain the above mentioned information, solicits response frames (e.g., clear to send frames) from one or more of the UHR STAs, wherein the transmission of the CTS frames, among other things, provides a confirmation from the UHR STAs that they will adopt the requested set of operational parameters for the reception of the pending DL BUs. In another embodiment, the Trigger frame may be a variant of a buffer status report poll (BSRP) Trigger frame, which may contain the above mentioned information, solicits buffer status reports (BSRs) from one or more of the STAs, which provides either: a confirmation from each of the UHR STAs that they will adopt the requested set of operational parameters; or a second set of operational parameters that an UHR STA intends to use for the reception of the pending DL BUs and/or reception of the pending UL BUs. In addition the UHR STA may also indicate for how long it intends to remain in a receive mode that uses this set of operational parameters.

The Trigger frame may be scheduled directly after the Beacon frame (example after a SIFS), and the STA 504 may respond with a UL Triggering frame (such as the response 510) that includes an indication that the STA 504 has transitioned to active mode (for example, by setting the PM bit to 0) or an enhanced PS mode if the STA 504 supports multiple MPDU RX, an indication of an updated RX NSS or RX BW the STA 504 intends to use for the current enhanced service period (SP), an indication of a duration of time for which the STA 504 intends to operate according to the indicated RX parameters, or a combination thereof. This information may be advertised in an operating mode (OM) Control or EHT OM Control field within a MAC header of the UL Triggering frame. In some implementations, the STA 504 may switch to PS mode, or a doze state, or to using the previous/original parameter sets, after the time duration indicated by the UL Triggering frame. In the absence of this information, the exchange of End of Service Period (EOSP)=1 and/or More Data (MD)=0 may be used to determine the end of the current enhanced SP.

In some implementations, the Duration field of a Beacon frame may be set to a non-zero value, thereby providing the STA 504 with a TXOP during which UL Triggering frames may be delivered. The STA 504 may use EDCA to contend for the TXOP (and discard an intra-BSS NAV of the Beacon frame) if the STA 504 does not support trigger functionality. As described herein, EDCA is a wireless media access mechanism that provides differentiated access by directing traffic to four access-category QoS priority queues. In particular, EDCA prioritizes traffic using priority tags (such as voice, video, best effort, and background), which provide a mechanism for implementing QoS at the MAC level. When contending for a TXOP, frames associated with the highest priority access category (such as voice) may have the lowest backoff values and, therefore, the highest probability of successfully obtaining the TXOP. The AP 502 can schedule group-addressed delivery after STAs with pending DL BU(s) are served. Delivery of group-addressed BUs is generally not latency-sensitive, but group-addressed BUs may need to be sent immediately after the DTIM beacon. Thus, if the pending DL BUs are latency-sensitive, they could be delayed by group delivery. The protocols described herein ensure that low latency pending DL BUs are sent before group-addressed frames.

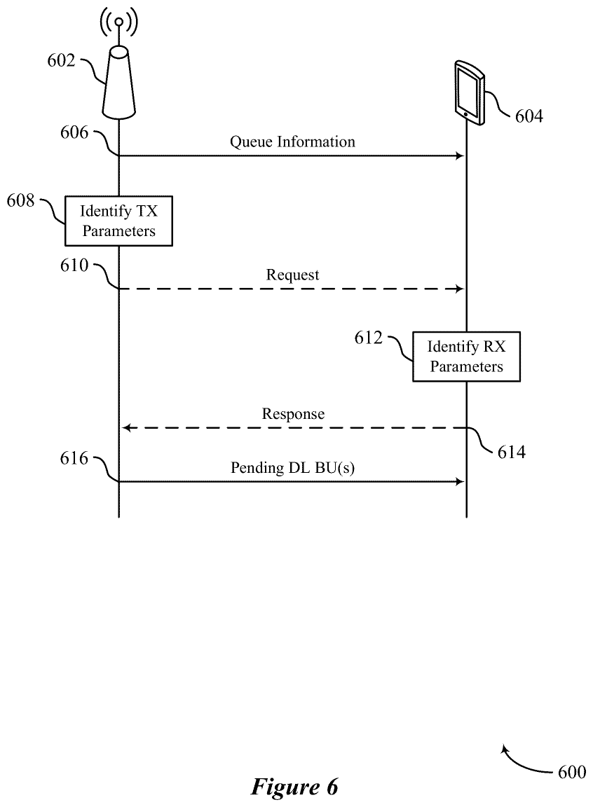

FIG. 6 shows an example process flow 600. The process flow 600 may implement or be implemented by aspects of the WLAN 100. For example, the process flow 600 includes an AP 602, which may be an example of aspects of a wireless AP, such as the AP 502 shown and described with reference to FIG. 5. The process flow also includes a STA 604, which maybe an example of aspects of a wireless STA, such as the STA 504 shown and described with reference to FIG. 5. In the following description of the process flow 600, operations between the AP 602 and the STA 604 may be added, omitted, or performed in a different order (with respect to the exemplary order shown).

At 606, the AP 602 may transmit an indication of queue information associated with one or more pending DL BUs for the STA 604 in an enhanced delivery mode. Further, the enhanced delivery mode may include a PS mode or an AM. The queue information may indicate a quantity of the one or more pending DL BUs for the STA 604, a time duration for which the one or more pending DL BUs have been pending, a time duration after which the one or more pending DL BUs will be dropped, a request for the STA to switch to an active mode or an enhanced PS mode for reception of the one or more pending DL BUs, a request for the STA to increase one or more operational parameters for reception of the one or more pending DL BUs, delivery status information associated with a set of communication links between the AP 602 and the STA 604, BSS load information associated with the set of communication links, or a combination thereof.

In some implementations, the delivery status information indicates a respective delivery wait time for each communication link in the set of communication links. One or both of the delivery status information or the BSS load information may be signaled or otherwise categorized on a per-TID or per-AC basis. The queue information may be signaled via an individually addressed frame (such as a frame that is addressed to the STA 604), a group-addressed frame (such as a frame that is addressed to one or more STAs for which the AP has queue information related to pending DL BUs), or a broadcast frame. In some implementations, the queue information may be provided via a QoS control field or a BSR field within a MAC header of a Trigger frame, a Beacon frame, a broadcast frame, a Link Recommendation frame, an individually addressed frame, or a TIM frame. In some implementations, the frame(s) containing the queue information may be scheduled after a Beacon frame from the AP 602.

In some implementations, the one or more framers indicate a list of UHR STAs (including the STA 604) with pending DL BUs and respective BSRs for each of the UHR STAs. Additionally, or alternatively, the queue information may indicate one or more UHR MLDs with pending DL BUs and respective communication links via which the UHR MLDs can receive the pending DL BUs. The queue information also may indicate a cumulative delay associated with delivery of the one or more pending DL BUs to the STA 604.

At 608, the AP 602 may identify, in accordance with the queue information associated with the one or more pending DL BUs, a first set of operational parameters (e.g., TX parameters) to use for transmission of the one or more pending DL BUs. The first set of operational parameters may include, for example, a TX BW, a TX NSS, or an MCS to use for transmission of the one or more pending DL BUs.

At 610, the AP 602 may optionally transmit a request for the STA 604 to use a second set of parameters for reception of the one or more pending DL BUs. The second set of parameters may include, for example, an RX BW, an RX NSS, or an MCS to use for reception of the one or more pending DL BUs. The request also may indicate a time period for which to use the second set of parameters. In some implementations, the AP 602 may transmit an indication of a time period in which the STA 604 is permitted to transmit UL Triggering frames or PS-Poll frames to the AP 602. In some implementations, the request may include an instruction for the STA 604 to switch to an awake state or an active mode to receive the one or more pending DL BUs from the AP 602.

At 612, the STA 604 may identify the second set of parameters to use for reception of the one or more pending DL BUs. The second set of parameters may include, for example, an RX BW, an RX NSS, or an MCS the STA 604 intends to use for reception of the one or more pending DL BUs. In some implementations, the second set of parameters selected/identified by the STA 604 may correspond to the set of RX parameters requested by the AP 602. In some implementations, the STA 604 may select the maximum RX BW of the STA 604 or the maximum RX NSS for reception of the DL BUs.

At 614, the STA 604 may optionally transmit an indication of the second set of parameters the STA intends to use for reception of the one or more pending DL BUs. In some implementations, the STA 604 may transmit, during a time period identified by the AP 602 (such as a time period indicated by a NAV of a Beacon frame), at least one UL Triggering frame or PS-Poll frame that triggers transmission of the one or more pending DL BUs from the AP 602. The UL Triggering frame or PS-Poll frame may include an indication that the STA 604 has transitioned to an active mode or an enhanced PS mode, an indication of the second set of parameters, an indication of a time duration for which the STA intends to remain in the active mode or the enhanced PS mode, an indication of a time duration for which the STA intends to use the second set of parameters, or a combination thereof.

At 616, the AP 602 may transmit the one or more pending DL BUs to the STA 604 in accordance with the queue information, and the STA 604 may use the second set of parameters to receive the one or more pending DL BUs from the AP 602. For example, the STA 604 may use a particular RX BW, RX NSS, and/or MCS to receive the one or more pending DL BUs from the AP 602. In some implementations, the STA 604 may return to PS mode (such as a doze state) once all pending DL BUS have been delivered. Additionally, or alternatively, the AP 602 may schedule group-addressed delivery after or while serving the STA 604.

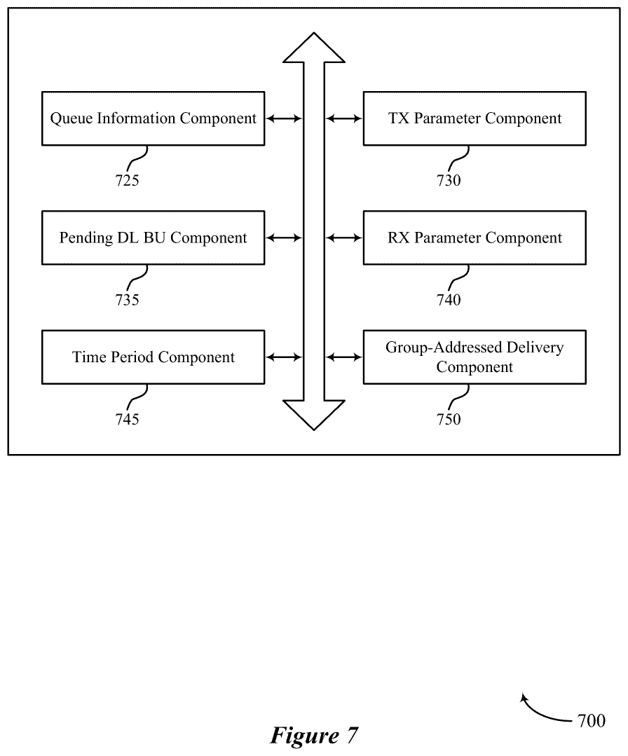

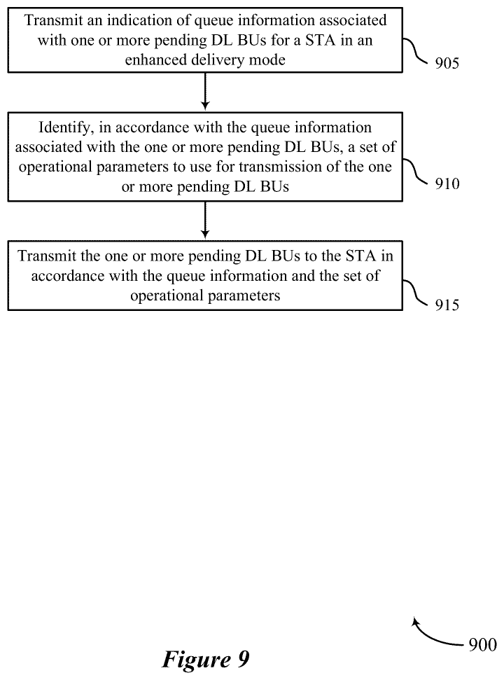

FIG. 7 shows a block diagram of an example wireless communication device 700 that supports techniques for enhanced DL data delivery. In some implementations, the wireless communication device 700 may be configured to perform one or more operations of the process 900 described with reference to FIG. 9. The wireless communication device 700 may include one or more chips, SoCs, chipsets, packages, components, or devices that individually or collectively constitute or include a processing system. The processing system may interface with other components of the wireless communication device 700, and may generally process information (such as inputs or signals) received from such other components and output information (such as outputs or signals) to such other components.

In some aspects, an example chip may include a processing system, a first interface to output or transmit information and a second interface to receive or obtain information. For example, the first interface may refer to an interface between the processing system of the chip and a transmission component, such that the wireless communication device 700 may transmit the information output from the chip. In such an example, the second interface may refer to an interface between the processing system of the chip and a reception component, such that the wireless communication device 700 may receive information that is then passed to the processing system. In some such implementations, the first interface also may obtain information, such as from the transmission component, and the second interface also may output information, such as to the reception component.

The processing system of the wireless communication device 700 includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein.

The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein.

Additionally, or alternatively, in some implementations, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some implementations, the wireless communication device 700 may be configurable or configured for use in an AP, such as the AP 102 described with reference to FIG. 1. In some other implementations, the wireless communication device 700 may be an AP that includes such a processing system and other components, including one or multiple antennas. The wireless communication device 700 may be capable of transmitting and receiving wireless communications in the form of, for example, wireless packets. For example, the wireless communication device 700 may be configurable or configured to transmit and receive packets in the form of physical layer PPDUs and MPDUs conforming to one or more of the IEEE 802.11 family of wireless communication protocol standards.

In some other implementations, the wireless communication device 700 may be configurable or configured to transmit and receive signals and communications conforming to one or more 3GPP specifications including those for 5G NR or 6G. In some implementations, the wireless communication device 700 also includes or may be coupled with one or more application processors which may be further coupled with one or more other memories. In some implementations, the wireless communication device 700 further includes at least one external network interface coupled with the processing system that enables communication with a core network or backhaul network that enables the wireless communication device 700 to gain access to external networks including the Internet.

The wireless communication device 700 may include a queue information component 725, a TX parameter component 730, a pending DL BU component 735, an RX parameter component 740, a time period component 745, and a group-addressed delivery component 750. Portions of one or more of the queue information component 725, the TX parameter component 730, the pending DL BU component 735, the RX parameter component 740, the time period component 745, and the group-addressed delivery component 750 may be implemented at least in part in hardware or firmware. For example, one or more of the queue information component 725, the TX parameter component 730, the pending DL BU component 735, the RX parameter component 740, the time period component 745, and the group-addressed delivery component 750 may be implemented at least in part by at least a processor or a modem. In some implementations, portions of one or more of the queue information component 725, the TX parameter component 730, the pending DL BU component 735, the RX parameter component 740, the time period component 745, and the group-addressed delivery component 750 may be implemented at least in part by a processor and software in the form of processor-executable code stored in memory.

The wireless communication device 700 may support techniques for wireless communication in accordance with implementations disclosed herein. The queue information component 725 may be capable of or otherwise configured to transmit an indication of queue information associated with one or more pending DL BUs for a STA in an enhanced delivery mode. The TX parameter component 730 may be capable of or otherwise configured to identify, in accordance with the queue information associated with the one or more pending DL BUs, a set of operational parameters to use for transmission of the one or more pending DL BUs. The pending DL BU component 735 may be capable of or otherwise configured to transmit the one or more pending DL BUs to the STA in accordance with the queue information and the set of operational parameters.

In some implementations, the RX parameter component 740 may be capable of or otherwise configured to transmit a request for the STA to use a second set of operational parameters for reception of the one or more pending DL BUs, where the one or more pending DL BUs are transmitted in accordance with the request.

In some implementations, the second set of operational parameters may be signaled via an OM Control field or an EHT OM Control field in a MAC header. In some implementations, the first set of operational parameters, the second set of operational parameters, or both include one or more of a BW, an NSS, or an MCS to use for reception of the one or more pending DL BUs. In some implementations, the BW includes a maximum BW of the STA. In some implementations, the NSS includes a maximum NSS supported by the STA.

In some implementations, the request from the AP includes an instruction for the STA to switch to an awake mode to receive the one or more pending DL BUs from the AP. In some implementations, the awake mode is an active mode or a PS mode with awake state, where the enhanced delivery mode includes the power save mode. In some implementations, the request indicates a duration of time for which to use the second set of operational parameters.

In some implementations, the RX parameter component 740 may be capable of or otherwise configured to receive an indication of a second set of operational parameters the STA intends to use for reception of the one or more pending DL BUS, where the one or more pending DL BUs are transmitted in accordance with the indication.

In some implementations, the first set of operational parameters, the second set of operational parameters, or both include a BW and an NSS the STA intends to use for DL reception during a current enhanced SP. In some implementations, the second set of operational parameters indicated by the STA are equivalent to the set of operational parameters requested by the AP.

In some implementations, the queue information indicates a quantity of the one or more pending DL BUs for the STA, a time duration for which the one or more pending DL BUs have been pending, a time duration after which the one or more pending DL BUs will be dropped, a request for the STA to switch to an active mode or an enhanced PS mode for reception of the one or more pending DL BUs, a request for the STA to increase one or more operational parameters for reception of the one or more pending DL BUs, delivery status information associated with a set of communication links, BSS load information associated with the set of communication links, or a combination thereof.

In some implementations, the delivery status information indicates a respective delivery wait time for each of the set of communication links. In some implementations, one or more frames containing the queue information are scheduled after a Beacon frame.

In some implementations, one or more frames indicate a list of UHR STAs with pending DL BUs and respective queue information for each of the UHR STAs, which includes the STA.

In some implementations, the delivery status information, the BSS load information, or both are signaled or categorized on a per traffic type basis, or differentiated per TID or per AC.

In some implementations, the queue information may be signaled via a frame that is individually addressed to the STA, a frame that is addressed to one or more STAs for which the AP has queue information about pending DL BUs, or a broadcast frame.

In some implementations, the queue information may be signaled via a QoS control field or a BSR control field of a MAC header of a frame. In some implementations, the queue information may be signaled via one or more of a Trigger frame, a Beacon frame, a broadcast frame, a Link Recommendation frame, an individually addressed frame, or a TIM frame.

In some implementations, the broadcast frame indicates UHR MLDs with pending DL BUs and a set of communication links via which the UHR MLDs, including the STA, can receive the pending DL BUs. In some implementations, the queue information indicates a cumulative delay associated with delivery of the one or more pending DL BUs to the STA.

In some implementations, the time period component 745 may be capable of or otherwise configured to transmit an indication of a time period in which the STA is permitted to transmit UL Triggering frames or PS-Poll frames to the AP. In some implementations, the time period component 745 may be capable of or otherwise configured to receive, during the time period, at least one UL Triggering frame or PS-Poll frame that triggers transmission of the one or more pending DL BUs from the AP.

In some implementations, the time period may be signaled via a NAV within a Beacon frame. In some implementations, the NAV may be indicated in a Duration/ID field of the Beacon frame or in an IE contained in the Beacon frame.

In some implementations, a first portion of the queue information may be signaled via a first IE that indicates whether the AP has pending DL BUs for the STA. In some implementations, a second portion of the queue information may be signaled via a second IE or field that indicates a quantity of the one or more pending DL BUs for the STA.

In some implementations, the second IE or field may be included in a Beacon frame or a broadcast frame. In some implementations, the queue information includes respective BSRs for a set of UHR STAs, including the STA, with pending DL BUs. In some implementations, the respective BSRs may be signaled per TID or per AC.

In some implementations, to support transmitting the queue information, the queue information component 725 may be capable of or otherwise configured to transmit, to a set of UHR STAs including the STA, a Beacon frame that schedules transmission of one or more Trigger frames. In some implementations, to support transmitting the queue information, the queue information component 725 may be capable of or otherwise configured to receive, from the STA, an UL Triggering frame in accordance with the Beacon frame.

In some implementations, the set of UHR STAs include STAs with pending DL BUs, STAs with pending DL delivery reports, or both. In some implementations, UL MU capabilities are disabled for the STA and the UL Triggering frame includes a MU request to send a TXOP Trigger frame. In some implementations, the Beacon frame and the UL Trigger frame are separated by at least a SIFS.

In some implementations, the UL Trigger frame includes an indication that the STA has transitioned to an active mode or an enhanced PS mode, an indication of a second set of operational parameters the STA intends to use for DL reception, an indication of a time duration for which the STA intends to remain in the active mode or the enhanced PS mode, an indication of a time duration for which the STA intends to use the second set of operational parameters, or a combination thereof.

In some implementations, the group-addressed delivery component 750 may be capable of or otherwise configured to schedule group-address delivery after or while serving the set of UHR STAs.

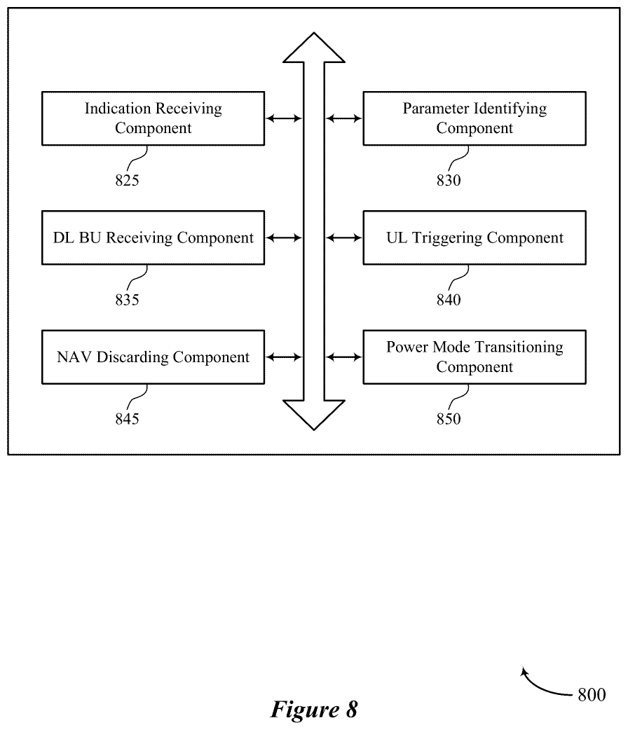

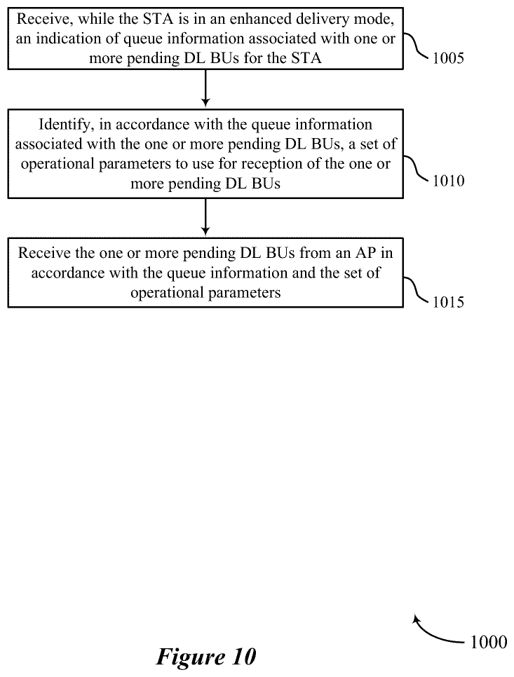

FIG. 8 shows a block diagram of an example wireless communication device 800 that supports techniques for enhanced DL data delivery. In some implementations, the wireless communication device 800 may be configured to perform one or more operations of the process 1000, as described with reference to FIG. 10. The wireless communication device 800 may include one or more chips, SoCs, chipsets, packages, components, or devices that individually or collectively constitute or include a processing system. The processing system may interface with other components of the wireless communication device 800, and may generally process information (such as inputs or signals) received from such other components and output information (such as outputs or signals) to such other components.

In some aspects, an example chip may include a processing system, a first interface to output or transmit information and a second interface to receive or obtain information. For example, the first interface may refer to an interface between the processing system of the chip and a transmission component, such that the wireless communication device 800 may transmit the information output from the chip. In such an example, the second interface may refer to an interface between the processing system of the chip and a reception component, such that the wireless communication device 800 may receive information that is then passed to the processing system. In some such implementations, the first interface also may obtain information, such as from the transmission component, and the second interface also may output information, such as to the reception component.

The processing system of the wireless communication device 800 includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein.

The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein.

Additionally, or alternatively, in some implementations, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some implementations, the wireless communication device 800 may be configurable or configured for use in a STA, such as the STA 104 described with reference to FIG. 1. In some other implementations, the wireless communication device 800 can be a STA that includes such a processing system and other components including multiple antennas. The wireless communication device 800 is capable of transmitting and receiving wireless communications in the form of, for example, wireless packets. For example, the wireless communication device 800 can be configurable or configured to transmit and receive packets in the form of physical layer PPDUs and MPDUs conforming to one or more of the IEEE 802.11 family of wireless communication protocol standards.

In some other implementations, the wireless communication device 800 may be configurable or configured to transmit and receive signals and communications conforming to one or more 3GPP specifications including those for 5G NR or 6G. In some implementations, the wireless communication device 800 may include or be coupled with one or more application processors, which may be further coupled with one or more other memories. In some implementations, the wireless communication device 800 further includes a user interface (such as a touchscreen or keypad) and a display, which may be integrated with the user interface to form a touchscreen display that is coupled with the processing system. In some implementations, the wireless communication device 800 may further include one or more sensors such as, for example, one or more inertial sensors, accelerometers, temperature sensors, pressure sensors, or altitude sensors, that are coupled with the processing system.

The wireless communication device 800 may include an indication receiving component 825, a parameter identifying component 830, a DL BU receiving component 835, a UL triggering component 840, a NAV discarding component 845, and a power mode transitioning component 850. Portions of one or more of the indication receiving component 825, the parameter identifying component 830, the DL BU receiving component 835, the UL triggering component 840, the NAV discarding component 845, and the power mode transitioning component 850 may be implemented at least in part in hardware or firmware. For example, one or more of the indication receiving component 825, the parameter identifying component 830, the DL BU receiving component 835, the UL triggering component 840, the NAV discarding component 845, and the power mode transitioning component 850 may be implemented at least in part by at least a processor or a modem. In some implementations, portions of one or more of the indication receiving component 825, the parameter identifying component 830, the DL BU receiving component 835, the UL triggering component 840, the NAV discarding component 845, and the power mode transitioning component 850 may be implemented at least in part by a processor and software in the form of processor-executable code stored in memory.

The wireless communication device 800 may support techniques for wireless communication in accordance with implementations disclosed herein. The indication receiving component 825 may be capable of or otherwise configured to receive, while the STA is in an enhanced delivery mode, an indication of queue information associated with one or more pending DL BUs for the STA. The parameter identifying component 830 may be capable of or otherwise configured to identify, in accordance with the queue information associated with the one or more pending DL BUs, a set of operational parameters to use for reception of the one or more pending DL BUs. The DL BU receiving component 835 may be capable of or otherwise configured to receive the one or more pending DL BUs from an AP in accordance with the queue information and the set of operational parameters.

In some implementations, the parameter identifying component 830 may be capable of or otherwise configured to receive a request for the STA to use a second set of operational parameters for reception of the one or more pending DL BUs, where the one or more pending DL BUs are received in accordance with the request.

In some implementations, the parameter identifying component 830 may be capable of or otherwise configured to transmit an indication of a second set of operational parameters the STA intends to use for reception of the one or more pending DL BUs, where the one or more pending DL BUs are received in accordance with the indication.

In some implementations, to support receiving the queue information, the indication receiving component 825 may be capable of or otherwise configured to receive a Beacon frame that schedules transmission of a Trigger frame. In some implementations, to support receiving the queue information, the UL triggering component 840 may be capable of or otherwise configured to transmit an UL Triggering frame in accordance with the Beacon frame. In some implementations, a Duration field of the Beacon frame may be set to a non-zero value to indicate a TXOP in which the STA can deliver the UL Triggering frame.

In some implementations, the UL Trigger frame includes an indication that the STA has transitioned to an active mode or an enhanced PS mode, an indication of a second set of operational parameters the STA intends to use for DL reception, an indication of a time duration for which the STA intends to remain in the active mode or the enhanced PS mode, an indication of a time duration for which the STA intends to use the second set of operational parameters, or a combination thereof.

In some implementations, the power mode transitioning component 850 may be capable of or otherwise configured to transition to a PS mode or a doze state after the time duration indicated by the UL Triggering frame. In some implementations, the time duration may be signaled via an EOSP field or an MD field.

In some implementations, to support receiving the queue information, the indication receiving component 825 may be capable of or otherwise configured to receive a Beacon frame that includes an intra-BSS NAV. In some implementations, to support receiving the queue information, the NAV discarding component 845 may be capable of or otherwise configured to discard the intra-BSS NAV from the Beacon frame in accordance with triggering capabilities of the STA. In some implementations, to support receiving the queue information, the UL triggering component 840 may be capable of or otherwise configured to transmit an UL Triggering frame to the AP after performing an EDCA contention procedure.

FIG. 9 shows a flowchart illustrating an example process 900 performable by a wireless communication device that supports techniques for enhanced DL data delivery. In some implementations, one or more operations of the process 900 may be implemented by a wireless AP or components thereof. For example, one or more operations of the process 900 may be performed by the wireless communication device 700 (as shown and described with reference to FIG. 7), operating as or within a wireless AP (such as the wireless AP 102 shown and described with reference to FIG. 1).

At 905, the wireless AP may transmit an indication of queue information associated with one or more pending DL BUs for a STA in an enhanced delivery mode. In some implementations, aspects of the operations of 905 may be performed by a queue information component 725, as described with reference to FIG. 7.

At 910, the wireless AP may identify, in accordance with the queue information associated with the one or more pending DL BUs, a set of operational parameters to use for transmission of the one or more pending DL BUs. In some implementations, aspects of the operations of 910 may be performed by a TX parameter component 730, as described with reference to FIG. 7.

At 915, the wireless AP may transmit the one or more pending DL BUs to the STA in accordance with the queue information and the set of operational parameters. In some implementations, aspects of the operations of 915 may be performed by a pending DL BU component 735, as described with reference to FIG. 7.

FIG. 10 shows a flowchart illustrating an example process 1000 performable by a wireless communication device that supports techniques for enhanced DL data delivery. In some implementations, one or more operations of the process 1000 may be implemented by a wireless STA or components thereof. For example, one or more operations of the process 1000 may be performed by the wireless communication device 800 (as shown and described with reference to FIG. 8), operating as or within a wireless STA (such as one of the wireless STAs 104 shown and described with reference to FIG. 1).

At 1005, the wireless STA may receive, while the STA is in an enhanced delivery mode, an indication of queue information associated with one or more pending DL BUs for the STA. In some implementations, aspects of the operations of 1005 may be performed by an indication receiving component 825, as described with reference to FIG. 8.

At 1010, the wireless STA may identify, in accordance with the queue information associated with the one or more pending DL BUs, a set of operational parameters to use for reception of the one or more pending DL BUs. In some implementations, aspects of the operations of 1010 may be performed by a parameter identifying component 830, as described with reference to FIG. 8.

At 1015, the wireless STA may receive the one or more pending DL BUS from an AP in accordance with the queue information and the set of operational parameters. In some implementations, aspects of the operations of 1015 may be performed by a DL BU receiving component 835, as described with reference to FIG. 8.

The following provides an overview of aspects of the present disclosure:

Aspect 1: A method for wireless communication at an AP, comprising: transmitting an indication of queue information associated with one or more pending DL BUs for a STA in an enhanced delivery mode; identifying, in accordance with the queue information associated with the one or more pending DL BUs, a plurality of operational parameters to use for transmission of the one or more pending DL BUs; and transmitting the one or more pending DL BUs to the STA in accordance with the queue information and the plurality of operational parameters.

Aspect 2: The method of aspect 1, further comprising: transmitting a request for the STA to use a second plurality of operational parameters for reception of the one or more pending DL BUs, wherein the one or more pending DL BUs are transmitted in accordance with the request.

Aspect 3: The method of aspect 2, wherein the second plurality of operational parameters are signaled via an OM control field or an EHT OM control field in a MAC header.

Aspect 4: The method of any of aspects 2 through 3, wherein the plurality of operational parameters, the second plurality of operational parameters, or both comprise one or more of a BW, NSS, or an MCS to use for reception of the one or more pending DL BUS.

Aspect 5: The method of aspect 4, wherein the BW comprises a maximum BW of the STA, and the NSS comprises a maximum NSS supported by the STA.

Aspect 6: The method of any of aspects 2 through 5, wherein the request from the AP includes an instruction for the STA to switch to an awake mode to receive the one or more pending DL BUs from the AP, and the awake mode is either an active mode or a PS mode with awake state, wherein the enhanced delivery mode includes the power save mode.

Aspect 7: The method of any of aspects 2 through 6, wherein the request indicates a duration of time for which to use the second plurality of operational parameters.

Aspect 8: The method of any of aspects 1 through 7, further comprising: receiving an indication of a second plurality of operational parameters the STA intends to use for reception of the one or more pending DL BUs, wherein the one or more pending DL BUs are transmitted in accordance with the indication.

Aspect 9: The method of aspect 8, wherein the second plurality of operational parameters comprise a BW and an NSS the STA intends to use for DL RX during a current enhanced SP.

Aspect 10: The method of any of aspects 8 through 9, wherein the second plurality of operational parameters indicated by the STA are equivalent to the plurality of operational parameters requested by the AP.

Aspect 11: The method of any of aspects 1 through 10, wherein the queue information indicates a quantity of the one or more pending DL BUs for the STA, a time duration for which the one or more pending DL BUs have been pending, a time duration after which the one or more pending DL BUs will be dropped, a request for the STA to switch to an active mode or an enhanced PS mode for reception of the one or more pending DL BUs, a request for the STA to increase one or more operational parameters for reception of the one or more pending DL BUs, delivery status information associated with a plurality of communication links, BSS load information associated with the plurality of communication links, or a combination thereof.

Aspect 12: The method of aspect 11, wherein the delivery status information indicates a respective delivery wait time for each of the plurality of communication links.

Aspect 13: The method of aspect 12, wherein one or more frames containing the queue information are scheduled after a Beacon frame.

Aspect 14: The method of any of aspects 12 through 13, wherein the one or more frames indicates a list of UHR STAs with pending DL BUs and respective queue information for each of the UHR STAs, which includes the STA.

Aspect 15: The method of any of aspects 11 through 14, wherein the delivery status information, the BSS load information, or both are signaled or categorized on a per traffic type basis, or differentiated per TID or per AC.

Aspect 16: The method of any of aspects 11 through 15, wherein the queue information is signaled via a frame that is individually addressed to the STA, a frame that is addressed to one or more STAs for which the AP has queue information about pending DL BUs, or a broadcast frame.

Aspect 17: The method of any of aspects 11 through 16, wherein the queue information is signaled via a QoS control field or a BSR control field of a MAC header of a frame.

Aspect 18: The method of any of aspects 1 through 17, wherein the queue information is signaled via one or more of a Trigger frame, a Beacon frame, a broadcast frame, a Link Recommendation frame, an individually addressed frame, or a TIM frame.

Aspect 19: The method of aspect 18, wherein the broadcast frame indicates UHR MLDs with pending DL BUs and a plurality of communication links via which the UHR MLDs, including the STA, can receive the pending DL BUs.

Aspect 20: The method of any of aspects 1 through 19, wherein the queue information indicates a cumulative delay associated with delivery of the one or more pending DL BUs to the STA.

Aspect 21: The method of any of aspects 1 through 20, further comprising: transmitting an indication of a time period in which the STA is permitted to transmit UL triggering frames or PS-Poll frames to the AP; and receiving, during the time period, at least one UL triggering frame or PS-Poll frame that triggers transmission of the one or more pending DL BUs from the AP.

Aspect 22: The method of aspect 21, wherein the time period is signaled via a NAV within a Beacon frame, and the NAV is indicated in a Duration/ID field of the Beacon frame or in an IE contained in the Beacon frame.

Aspect 23: The method of any of aspects 1 through 22, wherein a first portion of the queue information is signaled via a first IE that indicates whether the AP has pending DL BUs for the STA, and a second portion of the queue information is signaled via a second IE or field that indicates a quantity of the one or more pending DL BUs for the STA.

Aspect 24: The method of aspect 23, wherein the second information element or field is included in a Beacon frame or a broadcast frame.

Aspect 25: The method of any of aspects 1 through 24, wherein the queue information comprises respective BSRs for a plurality of UHR STAs, including the STA, with pending DL BUS.

Aspect 26: The method of aspect 25, wherein the respective BSRs are signaled per TID or per AC.

Aspect 27: The method of any of aspects 1 through 26, wherein transmitting the queue information comprises: transmitting, to a plurality of UHR STAs including the STA, a Beacon frame that schedules transmission of one or more Trigger frames; and receiving, from the STA, a UL Triggering frame in accordance with the Beacon frame.

Aspect 28: The method of aspect 27, wherein the plurality of UHR STAs include STAs with pending DL BUs, STAs with pending DL delivery reports, or both.

Aspect 29: The method of any of aspects 27 through 28, wherein UL MU capabilities are disabled for the STA and the UL Triggering frame comprises an MU RTS TXOP Trigger frame.

Aspect 30: The method of any of aspects 27 through 29, wherein the Beacon frame and the UL Triggering frame are separated by at least a SIFS.

Aspect 31: The method of any of aspects 27 through 30, wherein the UL Triggering frame indicates that the STA has transitioned to an active mode or an enhanced PS mode, an indication of a second plurality of operational parameters the STA intends to use for DL reception, an indication of a time duration for which the STA intends to remain in the active mode or the enhanced PS mode, an indication of a time duration for which the STA intends to use the second plurality of operational parameters, or a combination thereof.

Aspect 32: The method of any of aspects 27 through 31, further comprising: scheduling group-addressed delivery after or while serving the plurality of UHR STAs.

Aspect 33: A method for wireless communication by a STA, comprising: receiving, while the STA is in an enhanced delivery mode, an indication of queue information associated with one or more pending DL BUs for the STA; identifying, in accordance with the queue information associated with the one or more pending DL BUs, a plurality of operational parameters to use for reception of the one or more pending DL BUs; and receiving the one or more pending DL BUs from an AP in accordance with the queue information and the plurality of operational parameters.

Aspect 34: The method of aspect 33, further comprising: receiving a request for the STA to use a second plurality of operational parameters for reception of the one or more pending DL BUs, wherein the one or more pending DL BUs are received in accordance with the request.

Aspect 35: The method of any of aspects 33 through 34, further comprising: transmitting an indication of a second plurality of operational parameters the STA intends to use for reception of the one or more pending DL BUs, wherein the one or more pending DL BUs are received in accordance with the indication.

Aspect 36: The method of any of aspects 33 through 35, wherein receiving the queue information comprises: receiving a Beacon frame that schedules transmission of a Trigger frame; and transmitting a UL Triggering frame in accordance with the Beacon frame.

Aspect 37: The method of aspect 36, wherein a Duration/ID field of the Beacon frame is set to a non-zero value to indicate a TXOP in which the STA can deliver the UL Triggering frame.

Aspect 38: The method of any of aspects 36 through 37, wherein the UL Triggering frame indicates that the STA has transitioned to an active mode or an enhanced PS mode, an indication of a second plurality of operational parameters the STA intends to use for DL RX, an indication of a time duration for which the STA intends to remain in the active mode or the enhanced PS mode, an indication of a time duration for which the STA intends to use the second plurality of operational parameters, or a combination thereof.

Aspect 39: The method of aspect 38, further comprising: transitioning to a PS mode or a doze state after the time duration indicated by the UL Triggering frame.

Aspect 40: The method of any of aspects 38 through 39, wherein the time duration is signaled via an EOSP field or an MD field.

Aspect 41: The method of any of aspects 33 through 40, wherein receiving the queue information comprises: receiving a Beacon frame that includes an intra-BSS NAV; discarding the intra-BSS NAV from the Beacon frame in accordance with triggering capabilities of the STA; and transmitting a UL Triggering frame to the AP after performing an EDCA contention procedure.

Aspect 42: An apparatus for wireless communications at an AP comprising a processing system that includes processor circuitry and memory circuitry that stores code, the processing system configured to cause the AP to perform a method of any of aspects 1 through 32.

Aspect 43: An apparatus for wireless communications at an AP comprising at least one means for performing a method of any of aspects 1 through 32.

Aspect 44: A non-transitory computer-readable medium storing instructions executable by at least one processor to perform a method of any of aspects 1 through 32.

Aspect 45: An apparatus for wireless communications at a STA comprising a processing system that includes processor circuitry and memory circuitry that stores code, the processing system configured to cause the STA to perform a method of any of aspects 33 through 41.

Aspect 46: An apparatus for wireless communications at an STA comprising at least one means for performing a method of any of aspects 33 through 41.

Aspect 47: A non-transitory computer-readable medium storing instructions executable by at least one processor to perform a method of any of aspects 33 through 41.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. An apparatus for wireless communication at an access point (AP), comprising:
a processing system that includes processor circuitry and memory circuitry that stores code, the processing system configured to cause the apparatus to:
transmit an indication of queue information associated with one or more pending downlink buffered units for a station (STA) in an enhanced delivery mode;
identify, in accordance with the queue information associated with the one or more pending downlink buffered units, a plurality of operational parameters to use for transmission of the one or more pending downlink buffered units; and
transmit the one or more pending downlink buffered units to the STA in accordance with the queue information and the plurality of operational parameters.

2. The apparatus of claim 1, wherein the processing system is further configured to cause the apparatus to:
transmit a request for the STA to use a second plurality of operational parameters for reception of the one or more pending downlink buffered units, wherein the one or more pending downlink buffered units are transmitted in accordance with the request.

3. The apparatus of claim 2, wherein the second plurality of operational parameters are signaled via an operating mode control field or an extremely high throughput operating mode control field in a medium access control header.

4. The apparatus of claim 2, wherein the plurality of operational parameters, the second plurality of operational parameters, or both comprise one or more of a bandwidth, a number of spatial streams, or a modulation and coding scheme to use for reception of the one or more pending downlink buffered units.

5. The apparatus of claim 4, wherein:
the bandwidth comprises a maximum bandwidth of the STA, and
the number of spatial streams comprises a maximum number of spatial streams supported by the STA.

6. The apparatus of claim 2, wherein:
the request from the AP includes an instruction for the STA to switch to an awake mode to receive the one or more pending downlink buffered units from the AP, and
the awake mode is either an active mode or a power save mode with awake state, wherein the enhanced delivery mode includes the power save mode.

7. The apparatus of claim 2, wherein the request indicates a duration of time for which to use the second plurality of operational parameters.

8. The apparatus of claim 1, wherein the processing system is further configured to cause the apparatus to:
receive an indication of a second plurality of operational parameters the STA intends to use for reception of the one or more pending downlink buffered units, wherein the one or more pending downlink buffered units are transmitted in accordance with the indication.

9. The apparatus of claim 8, wherein the second plurality of operational parameters comprise a bandwidth and a number of spatial streams the STA intends to use for downlink reception during a current enhanced service period.

10. The apparatus of claim 8, wherein the second plurality of operational parameters indicated by the STA are equivalent to the plurality of operational parameters requested by the AP.

11. The apparatus of claim 1, wherein the queue information indicates a quantity of the one or more pending downlink buffered units for the STA, a time duration for which the one or more pending downlink buffered units have been pending, a time duration after which the one or more pending downlink buffered units will be dropped, a request for the STA to switch to an active mode or an enhanced power save mode for reception of the one or more pending downlink buffered units, a request for the STA to increase one or more operational parameters for reception of the one or more pending downlink buffered units, delivery status information associated with a plurality of communication links, basic service set load information associated with the plurality of communication links, or a combination thereof.

12. The apparatus of claim 11, wherein the delivery status information indicates a respective delivery wait time for each of the plurality of communication links.

13. The apparatus of claim 12, wherein one or more frames containing the queue information are scheduled after a beacon frame.

14. The apparatus of claim 12, wherein one or more frames indicate a list of ultra-high reliability STAs with pending downlink buffered units and respective queue information for each of the ultra-high reliability STAs, which includes the STA.

15. The apparatus of claim 11, wherein the delivery status information, the basic service set load information, or both are signaled or categorized on a per traffic type basis or differentiated per traffic identifier or per access category.

16. The apparatus of claim 11, wherein the queue information is signaled via a frame that is individually addressed to the STA, a frame that is addressed to one or more STAs for which the AP has queue information about pending downlink buffered units, or a broadcast frame.

17. The apparatus of claim 11, wherein the queue information is signaled via a quality-of-service control field or a buffer status report control field of a medium access control header of a frame.

18. The apparatus of claim 1, wherein the queue information is signaled via one or more of a trigger frame, a beacon frame, a broadcast frame, a Link Recommendation frame, an individually addressed frame, or a traffic indicator map frame.

19. The apparatus of claim 18, wherein the broadcast frame indicates ultra-high reliability multi-link capable devices with pending downlink buffered units and a plurality of communication links via which the ultra-high reliability multi-link capable devices, including the STA, can receive the pending downlink buffered units.

20. The apparatus of claim 1, wherein the queue information indicates a cumulative delay associated with delivery of the one or more pending downlink buffered units to the STA.

21. The apparatus of claim 1, wherein the processing system is further configured to cause the apparatus to:
transmit an indication of a time period in which the STA is permitted to transmit uplink triggering frames or power save polling frames to the AP; and
receive, during the time period, at least one uplink triggering frame or power save polling frame that triggers transmission of the one or more pending downlink buffered units from the AP.

22. The apparatus of claim 21, wherein:
the time period is signaled via a network allocation vector within a beacon frame, and
the network allocation vector is indicated by a field of the beacon frame or an information element contained in the beacon frame.

23. The apparatus of claim 1, wherein:
a first portion of the queue information is signaled via a first information element that indicates whether the AP has pending downlink buffered units for the STA, and
a second portion of the queue information is signaled via a second information element or field that indicates a quantity of the one or more pending downlink buffered units for the STA.

24. The apparatus of claim 23, wherein the second information element or field is included in a beacon frame or a broadcast frame.

25. The apparatus of claim 1, wherein the queue information comprises respective buffer status reports for a plurality of ultra-high reliability STAs, including the STA, with pending downlink buffered units.

26. The apparatus of claim 25, wherein:
the respective buffer status reports are signaled per traffic identifier or per access category.

27. The apparatus of claim 1, wherein, to transmit the queue information, the processing system is configured to cause the apparatus to:
transmit, to a plurality of ultra-high reliability STAs including the STA, a beacon frame that schedules transmission of one or more trigger frames; and
receive, from the STA, an uplink triggering frame in accordance with the beacon frame.

28. An apparatus for wireless communication at a station (STA), comprising:
a processing system that includes processor circuitry and memory circuitry that stores code, the processing system configured to cause the apparatus to:
receive, while the STA is in an enhanced delivery mode, an indication of queue information associated with one or more pending downlink buffered units for the STA;
identify, in accordance with the queue information associated with the one or more pending downlink buffered units, a plurality of operational parameters to use for reception of the one or more pending downlink buffered units; and
receive the one or more pending downlink buffered units from an access point (AP) in accordance with the queue information and the plurality of operational parameters.

29. A method for wireless communication at an access point (AP), comprising:
transmitting an indication of queue information associated with one or more pending downlink buffered units for a station (STA) in an enhanced delivery mode;
identifying, in accordance with the queue information associated with the one or more pending downlink buffered units, a plurality of operational parameters to use for transmission of the one or more pending downlink buffered units; and
transmitting the one or more pending downlink buffered units to the STA in accordance with the queue information and the plurality of operational parameters.
